(19) United States
(12) Patent Application Publication
(10) Pub. No.: US 2008/0101225 A1
(43) Pub. Date: May 1, 2008

(54) Systems and methods for capturing network packets

(76) Inventors: Mark A. Tassinari, Loomis, CA (US); David P. McMillan, Auburn, CA (US); Shaun Wakumoto, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/590,019

(22) Filed: Oct. 31, 2006

(51) Int. Cl. H04L 12/26

(52) U.S. Cl. 370/230; 370/235; 370/412

(57) ABSTRACT

In one embodiment a method for capturing network packets includes transmitting packets from and receiving packets with a network switch, and copying transmitted and received packets to a packet repository within memory of the network switch such that the packets are stored on the switch and available for later retrieval.

### BACKGROUND

When a customer experiences a problem with a local network, the customer often contacts technical support personnel for assistance in diagnosing and remedying the problem. In such a situation, the support technician will normally need detailed information as to what packets are being transmitted and received by the components of the network, such as by one or more of the network switches.

Information as to what packets are being transmitted and received by a switch can be obtained by using an independent packet capture device. In particular, such a device can be physically connected to a mirror port of the switch to collect packets transmitted and received by the switch. Often, the packet capture device is configured to decode the machine-language packets into a human-readable form. The decoded information can provide an indication as to what is happening on the network and therefore may reveal the source of the problem.

One disadvantage of the above method is that it requires the customer to physically access the switch that may comprise the troubled link of the network. This can be difficult for the customer in cases in which the switch is positioned in a remote location or a location that is, for one reason or another difficult to access. Furthermore, that method presumes that the customer possesses an appropriate packet capture device that is configured to collect the packets. Moreover, even assuming that the customer possesses a packet capture device, the customer must possess the requisite level of expertise to configure the mirror port if not already configured, use the packet capture device, and then share the human-readable information obtained from the device with the support technician.

### SUMMARY

Disclosed are systems and methods for capturing network packets. In one embodiment, a method includes transmitting packets from and receiving packets with a network switch, and copying transmitted and received packets to a packet repository within memory of the network switch such that the packets are stored on the switch and available for later retrieval.

### BRIEF DESCRIPTION OF THE DRAWINGS

The components in the drawings are not necessarily to scale, emphasis instead being placed upon clearly illustrating the principles of the present disclosure. In the drawings, like reference numerals designate corresponding parts throughout the several views.

FIG. 1 is block diagram of an embodiment of a system configured to capture network packets.

FIG. 2 is a block diagram of an embodiment of a network switch shown in FIG. 1.

FIG. 3 is block diagram of an embodiment of a computer shown in FIG. 1

FIG. 4 is a flow diagram that illustrates an embodiment of a method for capturing network packets.

FIG. 5 is a flow diagram that illustrates an embodiment of a method for storing network packets on a network switch.

FIG. 6 is a flow diagram that illustrates a further embodiment of a method for capturing network packets.

### DETAILED DESCRIPTION

As described above, current methods for capturing network packets can be difficult for customers to perform, especially for those customers that lack computer network expertise. As described below, however, network packet capture can be simplified through automatic capture and storage of network packets on the switches of the network. Once the packets are so stored, they can be retrieved through an appropriate file transfer process, and then forwarded to a support technician, if necessary. Accordingly, network problems can be diagnosed and remedied without the need to physically access a network switch and capture packet data with an independent packet capture device.

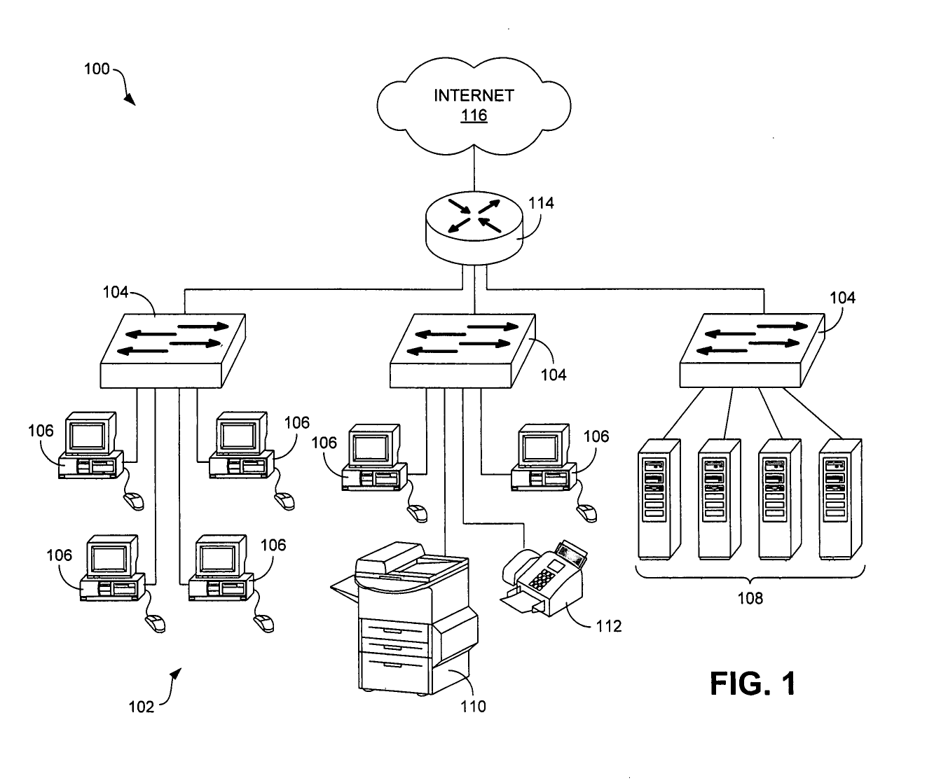

Referring now to the drawings, in which like numerals indicate corresponding parts throughout the several views, FIG. 1 illustrates an example system 100 that is configured to capture network packets. As indicated in that figure, the system 100 comprises multiple client devices 102 that are connected to multiple network switches 104 within a local area network (LAN). The client devices 102 can comprise any type of network-enabled device, i.e., a device that is configured to connect to and communicate over a computer network. In the example arrangement shown in FIG. 1, the client devices 102 include client computers 106, server computers 108, peripheral paper-handling equipment 110 (e.g., printer/photocopier), and an Internet Protocol (IP) telephone/digital sender 112. It is to be understood that those client devices 102 are mere examples and are only illustrated for purposes of explaining the packet capture process detailed in the following.

The network switches 104 are configured to bridge network segments and, in the example of FIG. 1, are each connected to a router 114, which is in turn connected to the Internet 116 or some other network. Such other networks can comprise, for instance, a further LAN or a wide area network (WAN).

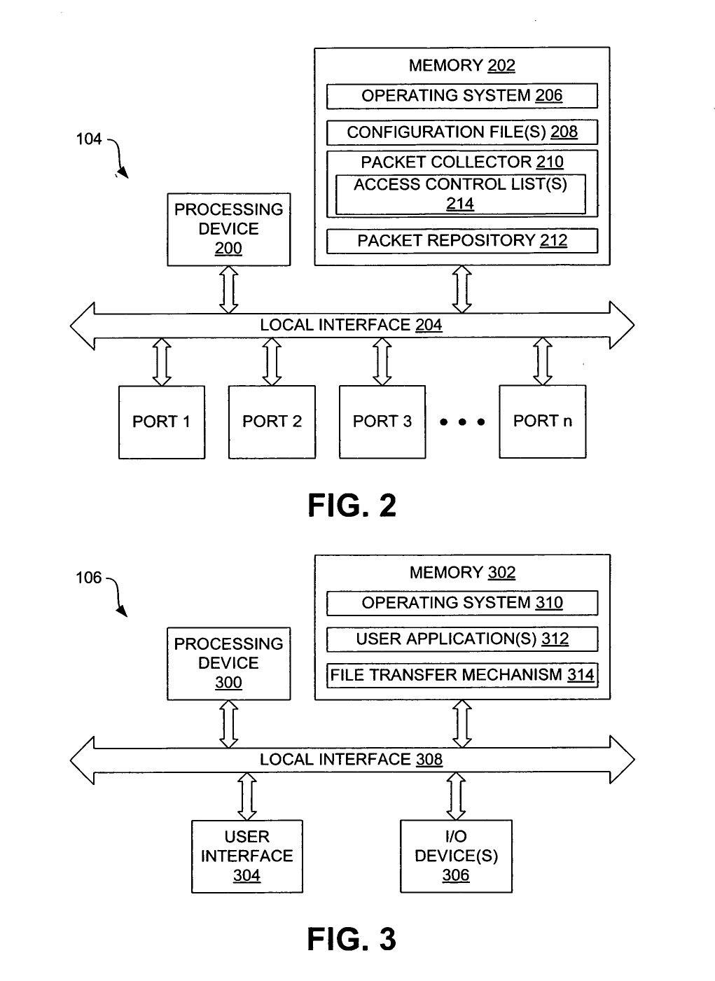

FIG. 2 is a block diagram illustrating an example architecture for one of the network switches 104. The switch 104 of FIG. 2 comprises a processing device 200, memory 202, and multiple ports 1-n, each of which is connected to a local interface 204.

The processing device 200 can comprise a microprocessor that is configured to execute instructions stored in memory 202 of the switch 104. Alternatively, the processing unit 200 can include one or more application specific integrated circuits (ASICs). The memory 202 comprises one or more nonvolatile memory elements, such as solid-state memory elements (e.g., flash memory elements). Although nonvolatile memory elements have been specifically identified, the memory 202 can further or alternatively comprise volatile memory.

The various ports 1-n are used to transmit packet data from the switch 104 and receive packet data from other devices, such as the client devices 102 in FIG. 1. Notably, one or more of the ports can be configured as a mirror port that receives and outputs a copy of all packets transmitted and received by the one or more ports to a monitoring port.

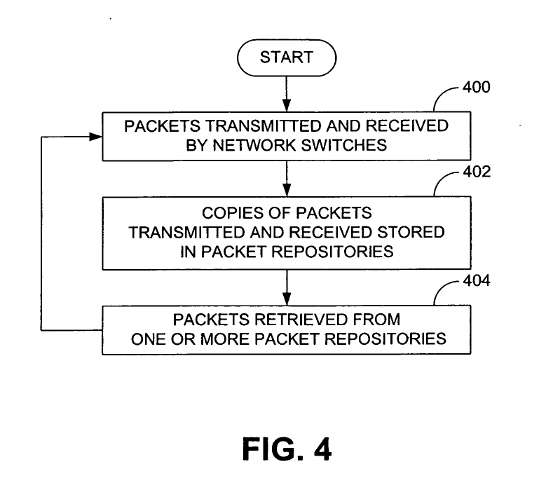

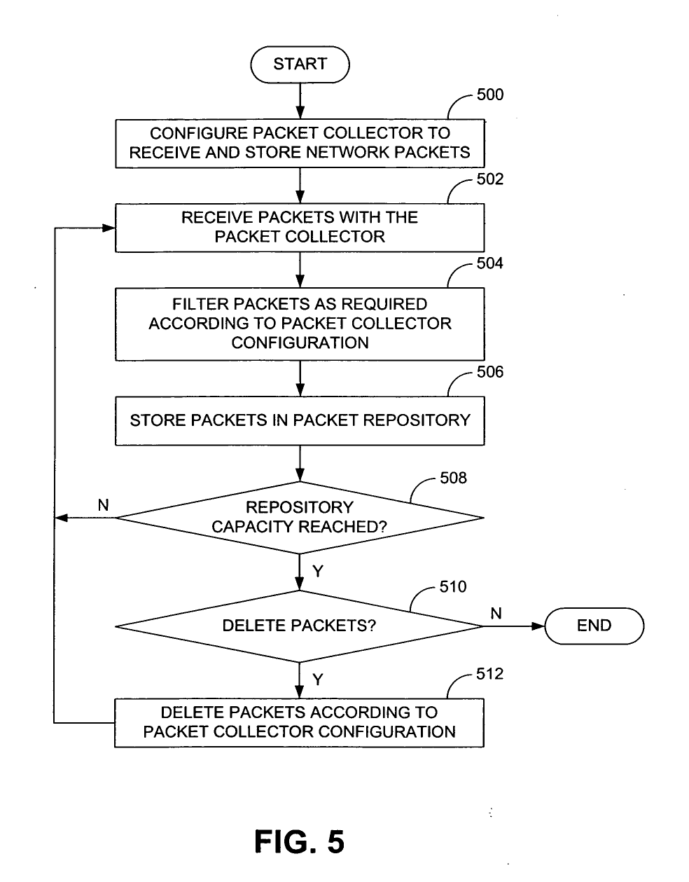

As further indicated in FIG. 2, stored in memory 202 is an operating system 206 that comprises the instructions that control the general operation of the switch 104. In addition, stored in memory 202 are one or more configuration files 208 that specify the configuration of the switch 104. In addition to the operating system 206 and the configuration file(s) 208, the memory 202 includes a packet collector 210 and a packet repository 212. As described in greater detail below, the packet collector 210 is configured to collect packets that are transmitted and received by the switch 104 and store at least some of them in the packet repository 212 to enable their retrieval by another device, such as a client computer 106 (FIG. 1). Optionally, the packet collector 210 can include one or more access control lists 214 that are used to filter the packets so that only desired packets are stored. Examples of operation of the packet collector 210 are provided in relation to FIGS. 4 and 5. Notably, although the packet collector 210 has been shown and described as a separate program, the functionality of the packet collector 210 could be incorporated into the operating system 206, if desired.

FIG. 3 is a block diagram illustrating an example architecture for one of the client computers 106. The computer 106 of FIG. 3 comprises a processing device 300, memory 302, a user interface 304, and at least one I/O device 306, each of which is connected to a local interface 308.

The processing device 300 can include a central processing unit (CPU) or a semiconductor-based microprocessor. The memory 302 includes any one of a combination of volatile memory elements (e.g., RAM) and nonvolatile memory elements (e.g., hard disk, ROM, tape, etc.).

The user interface 304 comprises the components with which a user interacts with the computer 106. The user interface 304 may comprise, for example, a keyboard, mouse, and a display, such as a cathode ray tube (CRT) or liquid crystal display (LCD) monitor. The one or more I/O devices 306 are adapted to facilitate communications with other devices and may include one or more communication components, such as a wireless (e.g., radio frequency (RF)) transceiver, a network card, etc.

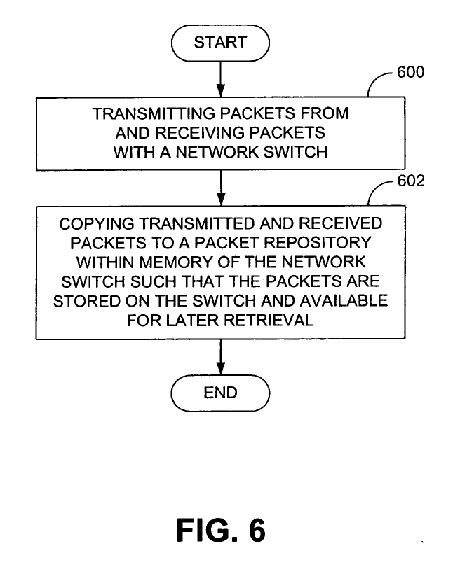

The memory 302 comprises various programs including an operating system 310, one or more user applications 312, and a file transfer mechanism 314. The operating system 310 controls the execution of other programs and provides scheduling, input-output control, file and data management, memory management, and communication control and related services. The user applications 312 can comprise substantially any application that executes on the computer 106, for example one or more of a word processing application, a spreadsheet application, an Internet browser, and the like. As described in greater detail in relation to FIG. 6, the file transfer mechanism 314 is configured to retrieve data from a network switch. More particularly, the file transfer mechanism 314 is configured to retrieve or receive network packets that have been stored by the switch in a packet mirroring or capture operation.

Various programs (i.e. logic) have been described herein. The programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in the flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

FIG. 4 illustrates an example method for capturing network packets. Beginning with block 400 of that figure, packets are transmitted and received by network switches. Substantially simultaneous to that transmission and receipt, copies of packets that are transmitted and received by the switches are stored in the respective packet repositories of the switches, as indicated in block 402. At an appropriate time, for example when a problem arises on the network, packets are retrieved from one or more of the switches, as indicated in block 404. By way of example, the packets are retrieved by a client computer that is connected to the network. At that point, the packets can be reviewed and/or forwarded to a support technician for trouble shooting or other analysis.

FIG. 5 illustrates an example method for storing network packets on a network switch that can, for instance, be used in the method described above in relation to FIG. 4. Beginning with block 500 of FIG. 5, the packet collector is configured to capture network packets. At minimum, the packet collector is configured to enable receipt of copies of all packets that are transmitted and received by the switch. By way of example, the switch can be reconfigured to mirror those packets to the packet collector instead of a mirror port. In addition, the packet collector optionally can be configured to filter the packets its receives so that it only stores particular packets and discards the rest. Such a measure may be advantageous in situations in which many packets are handled by the switch and/or if the memory capacity of the switch is relatively small. The packets can be filtered based upon substantially any rules or other criteria. By way of example, the packets can be filtered in relation to packet source address, packet destination address, packet protocol, port destination, packet type, packet precedence, type of service setting, etc. In some embodiments, such filtering can be performed in relation to information contained in the access control lists, which can specify which packets are to be retained and which need not be retained.

In addition to the above-described configuration, the packet collector can be configured to manage the switch's packet repository in which packets will be stored. Such management can include the deletion of packets to clear space for new packets to be stored. Various rules or other criteria can be used to determine which packets to delete and which to retain. In some embodiments, packets can be deleted in a first-in-first-out (FIFO) scheme such that the oldest packets in the repository are deleted first. In other embodiments, packets can be deleted in relation to policies specified by one or more of the access control lists. In still other embodiments, deletion may not be performed at all. For example, the packet collector can be configured to simply fill the packet repository and then halt further storage of packets until such time when the repository is cleared, for example by a command input by a network administrator.

Once the packet collector has been configured, it can receive packets, as indicated in block 502. With reference to block 504, the packet collector can, optionally, filter the packets according to its configuration. The packet collector can then store any packets that were not filtered out in the packet repository, as indicated in block 506. In some embodiments, entire packets are stored. In other embodiments, packet “slicing” is performed such that only portions of the packets are stored, to improve space utilization. In some embodiments, the repository simply comprises a file in which the packet information is stored. In other embodiments, the repository comprises a directory of separate files, for example, each file pertaining to a different packet type.

Turning to decision block 508, the packet collector can determine if the packet repository capacity has been reached. For example, it can be determined whether the packet repository or switch memory is actually full, or whether the repository or switch memory is at or near a maximum permissible fill level. In such a case, it may not be possible to store further packets in the packet repository. If the packet repository capacity has not been reached, flow returns to blocks 502-506 at which further packets are received and stored in the manner described above. However, if the packet repository capacity has been reached, the packet collector determines whether to delete packets, as indicated in decision block 510. If the packet collector has been configured not to delete packets, flow for the packet capture session is terminated and no further packets are stored. If, on the other hand, the packet collector has been configured to delete packets, flow continues to block 512 at which the packet collector deletes packets from the packet repository according to policies specified by the packet collector configuration. Once such deletion has been performed, new storage space will be available in the packet repository and, therefore, flow can again return to blocks 502-506 at which new packets can be received and stored.

As mentioned above, packets stored on a switch can be retrieved using a file transfer mechanism that, for example, executes on a client computer that is connected to the network. For instance, if a problem occurs on the network, packets can be retrieved from one or more of the network switches to investigate the source of the problem. Optionally, however, the retrieval process can be automated for the user (e.g., network administrator). For example, packet retrieval can be automatically performed on a periodic basis. In such a case, the packets that are retrieved from the switch can be deleted from switch memory. Assuming that the device that retrieved the packets (e.g., client computer) has greater storage capacity than the switch, a longer history of packet traffic can be archived. The period for packet retrieval in such an embodiment can be configurable to suit the particular environment of the customer's network. For example, if a first customer's switch handles a relatively large number of packets and a second customer's switch handles a relatively small number of packets, the frequency of packet retrieval may be greater for the first customer as compared to the second customer.

In other embodiments, the packet collector can be configured to automatically transmit stored packets to the client computer or another storage device when its associated packet repository nears capacity or contains a maximum permissible amount of data. In such a case, “retrieval” actually comprises intermittent receipt by the client computer of packets. In yet another embodiment, the packet collector can signal the client computer that its packet repository is nearing capacity to indicate that packet retrieval is necessary to avoid packet deletion or continue storage of new packets.

FIG. 6 illustrates a further example method for capturing network packets. The method of FIG. 6 comprises transmitting packets from and receiving packets with a network switch (600), and copying transmitted and received packets to a packet repository within memory of the network switch such that the packets are stored on the switch and available for later retrieval (602).

As can be appreciated from the foregoing, packet capture from network switches can be greatly simplified by storing the packets on the switch and retrieving them as desired. In such a scenario, network problems can be diagnosed and remedied without the need to physically access a network switch and capture packet data with an independent packet capture device.

Although various embodiments of systems and methods for network packet capture have been described herein, those embodiments are mere example implementations of the disclosed systems and methods. Therefore, alternative embodiments are possible, each of which is intended to fall within the scope of this disclosure. In one such alternative embodiment, the switch comprises a decoder process or program in switch memory that translates the packet data from machine code to human-readable information, thereby obviating the need for a decoder to be present on a separate computer that retrieves the packets from the switch.

Claimed are the following:

1. A method for capturing network packets, the method comprising:
transmitting packets from and receiving packets with a network switch; and
copying transmitted and received packets to a packet repository within memory of the network switch such that the packets are stored on the switch and available for later retrieval.

2. The method of claim 1, wherein copying transmitted and received packets to a packet repository within memory of the network switch comprises storing the transmitted and received packets within nonvolatile memory of the switch.

3. The method of claim 1, wherein copying transmitted and received packets to a packet repository within memory of the network switch comprises storing the transmitted and received packets within flash memory of the switch.

4. The method of claim 1, wherein copying transmitted and received packets to a packet repository comprises copying all packets transmitted from and received by the network switch over a given period of time to the packet repository.

5. The method of claim 1, wherein copying transmitted and received packets to a packet repository comprises copying only particular packets to the packet repository such that not all packets transmitted from and received by the switch over a given period of time are stored.

6. The method of claim 5, wherein copying only particular packets to the packet repository comprises filtering packets using predetermined criteria stored within switch memory.

7. The method of claim 6, wherein the predetermined criteria are dictated by at least one access control list stored within switch memory.

8. The method of claim 1, further comprising downloading copies of stored packets from the packet repository to a client computer.

9. The method of claim 1, further comprising automatically periodically downloading copies of stored packets from the packet repository to a client computer.

10. The method of claim 1, further comprising automatically transmitting copies of stored packets from the packet repository to a client computer when the packet repository contains a maximum permissible amount of data.

11. The method of claim 1, further comprising deleting packets from the packet repository.

12. The method of claim 11, wherein deleting packets comprises deleting oldest packets upon receiving new packets in a first-in-first-out scheme.

13. The method of claim 11, wherein deleting packets comprises deleting packets after downloading copies of the packets to a client computer.

14. A system for capturing network packets, the system comprising:
means for receiving all network packets transmitted from and receiving by a network switch; and
means provided on the network switch for storing selected transmitted and received packets in a packet repository within memory of the network switch such that the packets are available for later retrieval.

15. The system of claim 14, wherein the means for storing comprise flash memory of the switch.

16. The system of claim 14, further comprising means for filtering packets such that not all transmitted and received packets are stored within switch memory.

17. The system of claim 14, further comprising means for downloading stored packets from packet repository to a client computer.

18. The system of claim 14, further comprising means for automatically transmitting stored packets from the packet repository to a client computer either on a periodic basis or when the packet repository contains a maximum permissible amount of data.

19. The system of claim 14, further comprising means for deleting packets from the packet repository.

20. A computer-readable medium that contains a system for capturing network packets, the system comprising:
logic configured to receive network packets transmitted from and received by a network switch; and
logic configured to store selected packets transmitted and received by the network switch in a packet repository within memory of the switch such that packets are stored on the switch and are available for retrieval.

21. The computer-readable medium of claim 20, further comprising logic configured to filter packets such that not all transmitted and received packets are stored within switch memory.

22. The computer-readable medium of claim 20, further comprising logic configured to download stored packets from the packet repository to a client computer.

24. The computer-readable medium of claim 20, further comprising logic configured to automatically transmit stored packets from the packet repository to a client computer either on a periodic basis or when the packet repository contains a maximum permissible amount of data.

25. The computer-readable medium of claim 20, further comprising logic configured to delete packets from the packet repository.

26. A network switch comprising:
a processing device;
at least two ports; and
memory that includes a packet collector configured to receive network packets transmitted from and received by the network switch and to store selected packets transmitted and received by the switch in a packet repository also included within memory of the switch such that packets are stored on the switch and are available for retrieval.

27. The switch of claim 26, wherein the packet collector is further configured to filter packets such that not all transmitted and received packets are stored within switch memory.

28. The switch of claim 26, wherein the packet collector is further configured to download stored packets from the packet repository to a client computer.

29. The switch of claim 26, wherein the packet collector is further configured to automatically transmit stored packets from the packet repository to a client computer either on a periodic basis or when the packet repository contains a maximum permissible amount of data.

30. The switch of claim 26, wherein the packet collector is further configured to delete packets from the packet repository.
